(19) United States
(12) Patent Application Publication
(10) Pub. No.: US 2021/0371194 A1
(43) Pub. Date: Dec. 2, 2021

(54) CARRIER ASSEMBLY

(71) Applicant: BRYAN FREEMAN, SAN CLEMENTE, CA (US)

(72) Inventor: BRYAN FREEMAN, SAN CLEMENTE, CA (US)

(21) Appl. No.: 17/326,787

(22) Filed: May 21, 2021

Related U.S. Application Data
(60) Provisional application No. 63/028,153, filed on May 21, 2020.

(51) Int. Cl. B65D 90/00; B60P 7/08; B60P 7/10

(52) U.S. Cl. CPC B65D 90/0073; B60P 7/10; B60P 7/0815

(57) ABSTRACT

A system for holding items during transportation. A collapsible assembly is provided with a top main bar, a support bar, and a hanger bar. When collapsed, the top main bar and support bar are generally coaxial/co-linear and rest in a vertical position pointing directly down. For use, the support bar is raised and pivots relative to the top main bar, and engages a bracket to secure the top main bar in a more or less horizontal position. Once secured for use, the top main bar holds the hanger bar in a position allowing items to be hung therefrom, such as garments on standard garment hangers.

### CROSS REFERENCE TO RELATED APPLICATIONS

The present application claims the benefit of and priority to U.S. Provisional Patent App. No. 63/028,153, filed May 21, 2020 and titled CARRIER ASSEMBLY, the disclosure of which is incorporated herein by reference.

### BACKGROUND

A common practice for individuals changing residence is to rent a moving truck and load possessions into the truck. A large amount of cardboard waste is typically generated in this process, from packing items large and small into a variety of boxes. Garments can be hauled by folding and packing into relatively small boxes, or may be kept on hangers and packed into garment boxes having a bar therein for hanging coat hangers onto. Either way, the cardboard used for the small or large box is often used once or twice at most and then recycles. Garment boxes in particular are often unwieldy and will be destroyed by users when unpacking.

New and alternative solutions to aid in the transportation of such items are much desired, particularly with an eye to ease of use and reduced material waste.

### Overview

The present inventor has recognized, among other things, that a problem to be solved is the need for new and/or alternative devices or systems for securing items for transportation. Such systems may be used for holding and/or hanging items to be moved. Preferably, such a system would be installed in a vehicle, such as a moving truck, in a manner that allows it to be stowed when not in use so as to allow the vehicle to be used by a variety of users.

This overview is intended to provide an introduction to the subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1-2 are perspective renderings of an illustrative transport system as installed; and

FIGS. 3-6 are line drawings of the illustrative transport system.

### DETAILED DESCRIPTION

The following description focuses primarily on the use of the transport apparatus as described for securing and transporting items, such as garments on hangers. Despite decades of use, moving vans and trucks are, at least prior to the present invention, largely reliant on cardboard to secure many items. A system that can be used for holding items, while also being easy to stow out of the way, has long been desired.

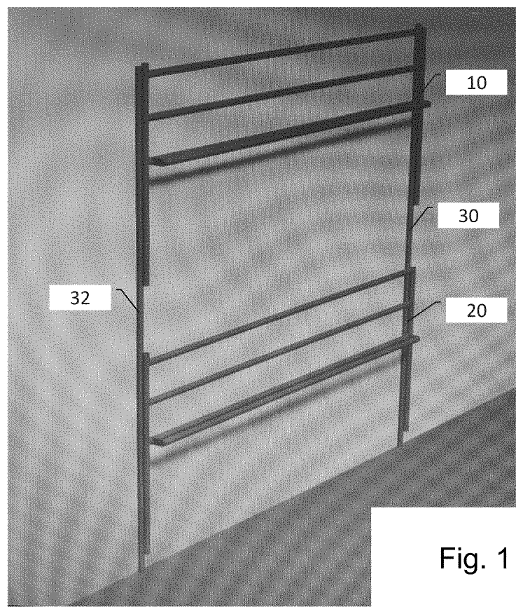

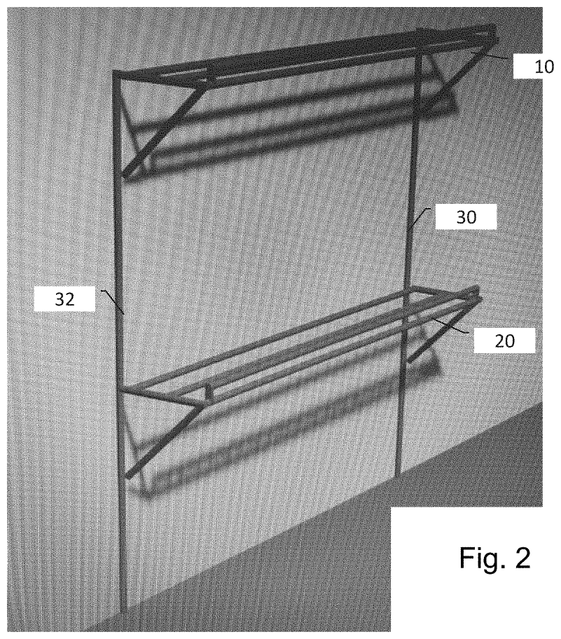

FIGS. 1-2 are perspective renderings of an illustrative transport system as installed. The installation may be, for example, in a moving truck or other vehicle, or a container for use in moving such as a portable on-demand storage (PODS®) container. A first apparatus 10 is shown in a collapsed or stowed configuration above a second apparatus 20, likewise in the stowed configuration. The two apparatuses are shown relative to vertical bars 30, 32, which may be pre-installed or may be part of the system itself. The vertical bars may instead be, for example, wooden boards. The use of both apparatuses 10, 20 in a stacked arrangement is optional; a single apparatus may be provided in some examples. Multiple such apparatuses may be placed in a line if desired as well.

FIG. 2 is a rendering of the apparatuses 10, 20 in a use configuration, extended outward from the wall as further explained below.

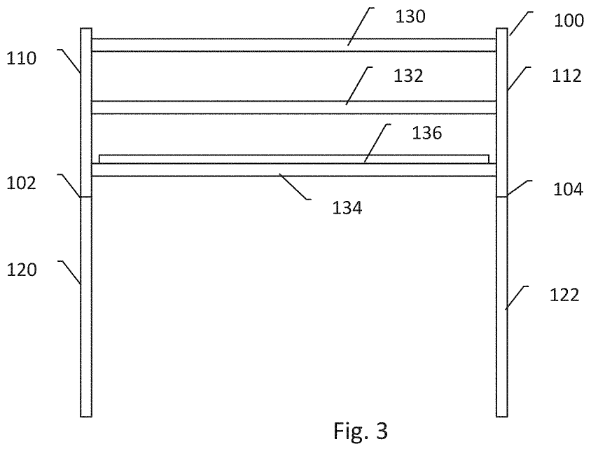

FIG. 3 is a front elevation line drawing of an apparatus 100. As noted previously, more than one apparatus may be used in a single location, such as having the apparatuses stacked one over the other on a wall, for example, or placed side-by-side along a wall, or in other combinations. Top main bars 110, 112 are shown and are pivotally coupled to support bars 120, 122 at pivot locations 102, 104. Cross bars 130, 132, 134 are shown, and a roll-off bar 136 may be optionally included as well. The cross bars 130, 132, 134 are shown connected to the top main bars 110, 112 at each end thereof. The roll-off bar 136 is shown coupled one of the cross bars 134 in this example, but may instead be coupled to the top main bars 110, 112 if desired. As noted, the roll-off bar 136 may be omitted in some examples. In addition, in some examples, only one cross bar 130, 132, 134 is included, making the apparatus only useable for hanging things, rather than both hanging and supporting, as shown below in FIG. 5.

In FIG. 3, the apparatus 100 is shown in a collapsed or stowed configuration, to similar to that shown in FIG. 1. The stowed configuration shown in FIGS. 1 and 3 preferably includes the apparatus hanging downward no more than three inches (more preferably, less than two inches) from the wall of the container or vehicle in which it is placed. The stowed configuration may enhanced in an example by providing a clip on the wall or a vertical member to hold one or more the main bars, cross bars, or support bars, for example, near to the wall or vertical member so that it cannot swing out of a stowed position near the wall during motion of the vehicle or container.

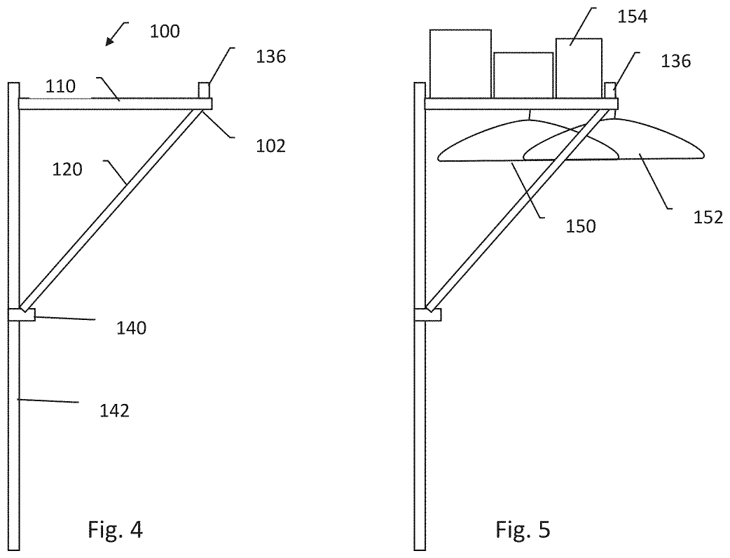

FIG. 4 is a side elevation view showing the apparatus 100 in a use configuration. Here, the system can be seen to include a stop bracket 140, secured to the vertical member 142 at a predetermined position. The support bar 120 is pivoted at 102 relative to the top main bar 110, and rests at its lower end on the stop bracket 140. The stop bracket 140 may optionally include a slot for receiving the support bar 120; if desired, a snap, strap, or screw (not shown) may be provided on the stop bracket or support bar 120 to lock into position. As shown, this placement of the support bar 120 places the top main bar 110 in a more or less horizontal position (approximately between 85 degrees and 95 degrees angle between the top main bar 110 and the vertical member 142.

In the extended configuration, the roll-off bar 136 can be seen to extend vertically up above the top main bar 110. Items placed on top of the apparatus 100 can be more securely held in place by the inclusion of this optional roll-off bar 136. In other examples, a single cross bar is included and the roll-off bar is omitted; in still other examples, multiple cross bars are provided and the roll-off bar 136 is omitted.

The vertical member 142 is shown for illustrative purposes; the system may simply attach to a wall rather than to the vertical member 142 if desired. If included, the vertical member 142 may be a bar or pipe, as shown for example in FIGS. 1-2, or may instead be a wooden board (1x4, 2x2, or 2x4, for example).

FIG. 5 shows use of the apparatus of FIG. 4. Hangers, such as standard coat hangers, for example, or any other suitable hanging element, can be used as shown at 150 and/or 152. A larger version of the apparatus may allow a middle hanger position as shown at 150, if desired; a smaller version (such as having a length of the main bar of 18 inches or less, such as 12 or 14 inches) may only allow for the outer hanger position shown at 152. Additional items for shipping may be placed above the apparatus on the cross bars, as shown at 154, if desired, and made more secure by the positioning of the roll-off bar 136.

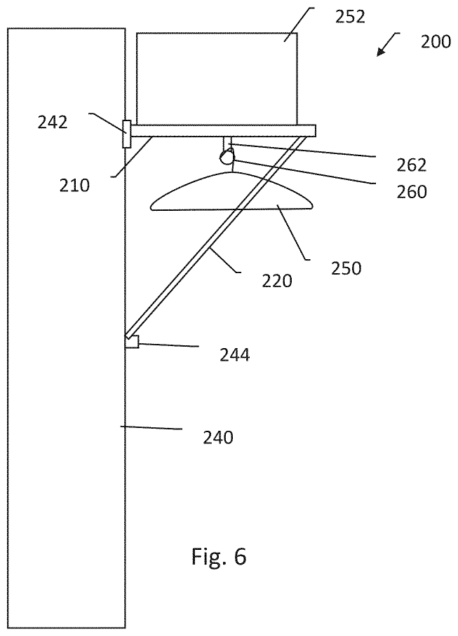

FIG. 6 shows another example. Here the apparatus 200 is shown including the top main bar 210 coupled in pivoting fashion to the support bar 220. Rather than separate vertical members, the apparatus here is attached directly to the wall 240, using a pivot bracket 242 that pivotally secures one end of the top main bar 210, and a stop bracket at 244 that also attaches directly to the wall 240. The wall 240 may be, for example, a wall of a container or vehicle configured for moving items. Separate pivot brackets 242 and stop brackets 244 may be used for each top main bar and each support bar, in some examples. The brackets 242, 244 may attach to rails inside of a truck or container, as are often provided in moving vehicles and/or containers. In other examples, the pivot brackets 242 and stop brackets 244 may be on their own horizontal bars configured for attachment to the wall 240.

Another modification in this example is that the hanger 250 can hang from a separate hanger bar 260 that is coupled by a hanger bracket 262 in pivoting fashion to the main bar 210 (or to a cross bar, if desired). When placed in a stowed position, the hanger bracket 262 pivots relative to the top main bar 210 to align therewith, allowing the entire apparatus to be collapsed to within 1-3 inches of the wall 240, effectively making the whole apparatus 200 unobtrusive when collapsed. By spacing the hanger bar from the main bar and/or cross bars, the hanger 250 can be easily removed from the apparatus without needing to move any items 252 held up on top of the apparatus. In this example, the roll-off bar is optionally omitted. In the example shown, the support bar 220 attaches to the end of the top main bar 210; in other examples, the support bar 220 can attach more in the middle of the top main bar 210, if desired, such as at a position at a quarter, third, half, two-thirds, or three quarters the length of the top main bar. In some examples, coupling to the end of the main top bar simplifies the design to ensure easy collapse to a fully stowed configuration.

The pivoting attachment described above may use any suitable structure to be achieved. In some examples, pivoting attachment may be by the use of, for example and without limitation, a bolt, rivet, a pin, and may be further facilitated by using a compound securing member such as a stainless-steel bolt within a sleeve such as a hard plastic to allow quiet pivoting action. Pivoting attachment may be spring loaded, if desired, though in most examples the support bar 120 is used to secure everything in place without any spring action.

Placement may be in a rental truck, as indicated above, though other uses are also contemplated, including, without limitation, in any transportation vehicle (airplane, automobile, train, boat), as well as in shipping containers, such as a portable on-demand storage (PODS®) type of system.

The overall size of the apparatus may vary to a significant extent. Some examples have a total width in the range of about 36 to about 100 inches, or about 48 to about 84 inches, or about 60 inches. In an example, the vertical supports may be spaced a standard width, such as 48 inches, and the apparatus can have a width of 48 inches for a “narrow” size, or 96 inches for a “wide” size. For longer spans, at third (or more) top main bar 110 and/or support bar 120 can be provided between the ends for additional strength.

The top main bar 110 may have a length in the range of about 12 inches to about 36 inches, or more or less, as desired. In some examples, the top bar has a length of about 18 inches, such that a standard 18-inch hanger can be held at the end thereof (as shown at 152 in FIG. 5), allowing room between the wall and the hanger center to facilitate the hanger having a jacket or other relatively bulky item thereon. In other examples, the top main bar 110 has a greater length to allow hanging at shown at 150 in FIG. 5, with the hanger more central to the top main bar 110. This configuration, using for example a top main bar width of 24 to 36 inches, may allow placement of hangers on the apparatus's middle-position cross bar while preventing a larger item (such as a mattress) from falling against and pressing into any garments being held, as the larger item may rest against the end of the top main bar and/or the roll-off bar 136 and/or an outer cross bar (such as bar 134 in FIG. 3).

The various bars noted may be round, square, rectangular, square-ish (sqround), or any other suitable shape. ½ inch to 2-inch bars, for example, may be used. The apparatus may be formed of individual bars welded or otherwise secured together (such as by bolting). It may instead be cast or molded, as desired. Any suitable material may be used, including for example, metal (steel, aluminum, tin, copper), wood, plastics and/or synthetics (polyvinyl chloride, for example), composites, etc. One example uses ½ inch square aluminum bars or ½ inch aluminum pipes, for example, welded together where needed and joined together in pivoting manner where needed.

The cross bars may be adapted to receive a standard hanger. For example, the diameter or width, whether round, square, square-ish, or any other suitable shape, may be sized to receive the hook portion of a standard hanger. In some examples, the diameter or width may be in the range of about 0.25 to 1.75 inches, or 0.5, 0.75, 1.0, or 1.25 inches. The opening on a hanger hook is sometimes reduced by the shape of the hook to accommodate a bar of at most 2 inches; to avoid issues with specialty hangers, the diameter of a bar adapted to receive a standard hanger may be, for example, less than 1.75 inches, with a diameter of 1 inch or less preferred in some examples.

In a rental context, such as a rental truck or moving container, use may be tracked for lessees by placing a plastic or paper wrapping about the pieces thereof when the system is in a stowed configuration as shown in FIG. 1. If the user removes the plastic or paper wrapping to take the apparatus out of the stowed configuration, the rental company can determine that the apparatus was put to use, and the user can be charged a rental fee. If the plastic or paper wrapping is intact, the rental company knows the apparatus was not used, and no fee would be charged.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. An apparatus for holding products for transport, the apparatus comprising:
at least first and second top main bars having a first end pivotally coupled relative to a wall and a second end;
at least first and second support bars each having a first end pivotally coupled, respectively, to the first and second top main bars, and a second end; and
at least a first cross bar having a first end coupled to the first top main bar and a second end coupled to the second top main bar, the cross bar adapted to receive a standard hanger thereon.

2. The apparatus of claim 1 wherein the at least first and second support bars are pivotally coupled to the second ends, respectively, of the first and second top main bars.

3. The apparatus of claim 1, further comprising second and third cross bars.

4. The apparatus of claim 1, further comprising a roll-off bar positioned near the end of the first and second top main bars to prevent an item placed on top of the apparatus from rolling off during transportation.

5. The apparatus of claim 1, further comprising a pivot bracket coupled pivotally to the first end of the first top main bar, the pivot bracket being secured to a truck or container wall.

6. The apparatus of claim 5 further comprising a first stop bracket also secured to the truck or container wall, wherein the apparatus defines two configurations:
a use configuration in which the second end of the first support member is coupled to the first stop bracket, thereby holding the first and second top main bars in a generally horizontal position, relative to the wall; and
a stowed configuration in which the entire apparatus hangs vertically from the pivot bracket in a distance of less than three inches from the wall.

7. The apparatus of claim 1, wherein the first ends of the first and second top main bars are secured to first and second vertical members, the apparatus further comprising first and second stop brackets also coupled to the first and second vertical members, wherein the apparatus defines two configurations:
a use configuration in which the second end of the first support member is coupled to the first stop bracket, thereby holding the first and second top main bars in a generally horizontal position, relative to the wall; and
a stowed configuration in which the entire apparatus hangs vertically from the first ends of the first and second top main bars in a distance of less than three inches from the wall.

8. An apparatus for holding products for transport, the apparatus comprising:
at least first and second top main bars having a first end pivotally coupled relative to a wall and a second end;
at least first and second support bars each having a first end pivotally coupled, respectively, to the first and second top main bars, and a second end; and
at least a first cross bar having a first end coupled to the first top main bar and a second end coupled to the second top main bar;
a hanger bar; and
first and second hanger brackets coupled to the first and second top main bars and holding therebetween the hanger bar.

9. An apparatus for holding products for transport, the apparatus comprising:
at least first and second top main bars having a first end pivotally coupled relative to a wall and a second end;
at least first and second support bars each having a first end pivotally coupled, respectively, to the first and second top main bars, and a second end; and
at least a first cross bar having a first end coupled to the first top main bar and a second end coupled to the second top main bar;
a hanger bar; and
first and second hanger brackets coupled to the first cross bar and holding therebetween the hanger bar.
